(19) United States
(12) Patent Application Publication
(10) Pub. No.: US 2004/0086161 A1
(43) Pub. Date: May 6, 2004

(54) Automated detection of lung nodules from multi-slice CT image data

(76) Inventors: Radhika Sivaramakrishna, Union City, CA (US); John S. Birbeck, San Francisco, CA (US)

Correspondence Address: William A Blake, Jones Tullar & Cooper PC, P O Box 2266 Eads Station, Arlington, VA, 22202, US

(21) Appl. No.: 10/289,188

(22) Filed: Nov. 5, 2002

(51) Int. Cl. G06K 9/00

(52) U.S. Cl. 382/131

(57) ABSTRACT

An automated method and system for detecting lung nodules from thoracic CT images employs an image processing algorithm (22) consisting of two main modules: a detection module (24) that detects nodule candidates from a given lung CT image dataset, and a classifier module (26), which classifies the nodule candidates as either true or false to reject false positives amongst the candidates. The detection module (24) employs a curvature analysis technique, preferably based on a polynomial fit, that enables accurate calculation of lung border curvature to facilitate identification of juxta-pleural lung nodule candidates, while the classification module (26) employs a minimal number of image features (e.g., 3) in conjunction with a Bayesian classifier to identify false positives among the candidates.

### BACKGROUND OF THE INVENTION

1. Field of the Invention

The present invention relates in general to an automated method and system that are particularly suited for detecting cancerous lung nodules in thoracic CT images. An algorithm is employed that identifies potential lung nodule candidates using curvature, size and shape analysis. The algorithm uses a Bayesian classifier operating on selected features of the nodule candidates to distinguish between true nodules and regions known as false positives that are not nodules.

2. Description of the Background Art

Lung cancer is the leading cause of cancer death in the United States. Although the overall five-year survival rate of lung cancer is only about 15%, the five-year survival rate for lung cancer detected in the early stages (e.g. Stage 1 lung cancer) is about 60-70%. Thus it is important to detect lung cancer at an early stage to improve the survival rate.

Lung cancer appears in the form of nodules or lesions in the lungs that are attached to the lung wall (known as juxta-pleural nodules), attached to major vessels or other linear structures, or appear as solitary nodules within the lung. Computed tomography (CT) is the most sensitive imaging modality for the detection of lung cancer at an early stage. However, the volumetric data acquired by CT scanners produces a large number of images for radiologists to interpret. Accurate identification of the nodules is also necessary to make quantitative estimates on lesion load in longitudinal studies of patients under treatment.

While computer-aided diagnosis (CAD) has been used for early detection of cancer in other areas of the body, like the breast, CAD efforts to detect lung cancer early on conventional thoracic CT images has primarily remained a research effort because of the low sensitivity and high false positive rate (FPR) of current detection algorithms. The low sensitivity and high FPR of current algorithms is due in larger part to the complicated nature of the algorithms, which often rely on the use of neural networks and rule-based schemes to identify potential nodule candidates and then classify the candidates as either true or false. This shortcoming has prompted researchers to develop CAD algorithms to work with high-resolution (HR) CT images of the lungs. Although these CAD algorithms developed on HRCT data have demonstrated higher sensitivity with a lower FPR, HRCT has one notable drawback that prevents it from being a practical solution to the detection problem at the present time. In particular, HRCT is typically performed with a slice-thickness of 1 mm, as opposed to 3 mm or more in conventional CT, which significantly increases the number of images to analyze. As a result, a need therefore remains for an accurate detection technique for the early detection of lung cancer nodules in conventional CT images.

### BRIEF SUMMARY OF THE INVENTION

The present invention addresses the foregoing need through provision of an automated method and system that is particularly suited for detecting lung nodules in thoracic CT images and employs a novel image processing algorithm for detection and classification of image objects, such as nodules. In a preferred embodiment for detecting lung nodules, the algorithm consists of two main modules, a detection module that detects nodule candidates from a given lung CT image dataset, and a classifier module, which classifies the nodule candidates as either true or false to reject false positives amongst the candidates. Both modules provide increased accuracy and decreased complexity as compared with prior art techniques by eliminating the need for neural networks or rule-based analysis schemes. The detection module employs a curvature analysis technique, preferably based on a polynomial fit, that enables accurate calculation of lung border curvature to facilitate identification of juxta-pleural lung nodule candidates. The classification module employs a minimal number of image features (e.g., 3) in conjunction with a Bayesian classifier to identify false positives.

In the detection module, a CT image slice is first processed to identify the borders of each lung. Each of these borders is then analyzed to identify any juxta-pleural nodules that may be present along the borders. In addition, the interior of each lung, which is defined by the image space within the lung borders, is analyzed to identify any solitary nodules as those pixels within each lung border that have a gray value greater than the fixed threshold.

A first key feature of the invention is the manner is which juxta-pleural nodules are identified. Based on the knowledge that juxta-pleural nodules appear along the lung borders as indented, sharply curved structures, a curvature and size analysis technique can be employed in the following manner to identify these nodules. First, the lung borders in the image are identified. The curvature at each of a plurality of points along the lung borders is then calculated. In the preferred embodiment, pixels in an image slice along each border are first ordered so that they are contiguous to facilitate generation of a contour along the lung border. The curvature at every point along the contour is then calculated, preferably using a polynomial, such as a 2^{nd} degree polynomial, which is fit over a set of multiple points with the current point in the center. The resulting curvature values are then thresholded to identify all points along each lung border that have a curvature exceeding a predetermined value, this value being selected based on the knowledge of known curvature values in the vicinity of typical juxta-pleural nodules.

Since the curvature is expected to peak on either side of a nodule, spaced pairs of these high curvature points are analyzed to determine which can be end points defining regions that represent potential nodules in the image. In the preferred embodiment, this analysis includes the following steps. The Euclidean distance between point pairs and the curve-length-to-Euclidean-distance ratio between point pairs are calculated. If a point pair has a Euclidean distance within a specified range and the ratio between curve length and Euclidean distance is within a specified range, then the pair defines a region that represents a potential nodule. However, if the maximum length or maximum width of a region is too large to be considered a true nodule, then it is rejected. Additionally, if the midpoint of the line joining the endpoints of the potential nodule is inside the lung border, the nodule is rejected, since true juxta-pleural nodules are expected to be outside the lung border. Once the final list of juxta-pleural nodule candidates is assembled, it is combined with the image containing solitary nodule candidates. The resulting image contains a plurality of regions that represent potential lung nodules.

The detection module also preferably employs a technique to eliminate regions representing potential nodules in the image at this point that are overlapping with or concatenated to each other. Hence, after all slices have been analyzed as described above, a different procedure is preferably used to break up regions that exceed a size threshold and potentially contain concatenated nodules. The procedure uses the known Euclidean Distance Transform (EDT) operator in an iterative manner. Starting with a predetermined Euclidean distance threshold (e.g., 1), the number of independent regions (obtained using a region growing procedure) is used as a stopping criterion. At each iteration, this number is compared to the number at the previous iteration. If the number of regions has increased, then the EDT operator is applied and the region resulting from the EDT threshold operation replaces the current large region. If this number remains the same, and there still remains a large region, then the EDT threshold is increased (e.g., by 1) and the procedure is repeated. An iteration count is maintained throughout and if this exceeds a threshold (e.g., 10), then the process stops. Finally, all 3D regions larger than a set threshold are excluded, thus leaving a final set of regions representing potential nodules for analysis by the classifier module.

Even though the detection module uses a number of parameters to identify potential nodules accurately, at least some number of regions will likely be identified as nodule candidates, which upon further analysis, can be rejected as “false positives.” A classifier module is therefore preferably employed that uses a multi-feature Bayesian classifier to separate the set of nodule candidates emerging from the detection module into true and false classes. In the preferred embodiment, the Bayesian classifier is based on eigenvalue and gray level analysis. More particularly, the classifier preferably employs three characteristic features that are known to distinguish true nodules from false positives. These features are: (1) the ratio of minimum and maximum eigenvalues of the co-variance matrix of the pixel coordinates making up each nodule candidate; (2) the maximum eigenvalue of the co-variance matrix; and (3) the average gray value of the pixels in the nodule candidate. The first two, eigenvalue features are used to distinguish long thin structures (which are more indicative of bronchial false positives) from true nodules (which are more likely to be round). The average gray level feature is used to remove false positives that are either brighter or darker than typical nodules.

In contrast with previous techniques, the classifier uses far fewer features and hence has a greater likelihood of being generalized to a larger dataset. In addition, unlike rule-based classification schemes used in many prior art algorithms to remove false positives, a quadratic Bayesian classifier can more accurately determine which features are important. A quadratic Bayesian classifier also avoids the problem of setting hard thresholds. In the preferred embodiment, each class, true and false, is modeled as a multivariate Gaussian probability density function (pdf). The pdfs of both classes can be employed to calculate the log likelihood ratio (llr) value for each nodule detection. A threshold llr value is then employed to separate the nodule candidates into the true and false class sets. The threshold value is preferably determined initially based on past performance on known nodule sets using a resubstitution method. Once a reliable threshold is calculated, it can then be applied to unknown nodule sets using a holdout method.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 is a block diagram of a system for acquiring and analyzing CT volume images in accordance with a preferred embodiment of the present invention;

FIG. 2 is a flow chart for a detector module portion of an algorithm employed in the preferred embodiment for detecting and classifying lung nodules in CT volume images;

FIG. 3 is a flow chart for a sub-module in the detector module of FIG. 2 for detecting potential nodule candidates;

FIG. 4 is a flow chart for a sub-module in the detector module of FIG. 2 for separating concatenated nodule regions that have been detected by the sub-module of FIG. 3;

FIG. 5 is a flow chart for a classifier module of the algorithm employed in the preferred embodiment that classifies nodule candidates generated by the detector module of FIG. 2 as either being nodules (true) or not nodules (false);

FIG. 6 is a CT image slice of a person's thorax, which is of the type for which the algorithm of the present invention can be employed to identify lung nodules therein;

FIG. 7 is the CT image of FIG. 6 after thresholding;

FIG. 8 is an image illustrating extraction of lung borders from the image of FIG. 7; and

FIG. 9 is an image showing extraction of nodule candidates from the image of FIG. 7 that are identified by the detector module of FIG. 2.

### DETAILED DESCRIPTION OF THE INVENTION

The preferred embodiment of the present invention employs a two-module algorithm to detect potential lung nodules in each of a plurality of CT image slices and then classify the potential nodules as either nodules (true) or not nodules (false). It should be understood, however, that the invention is not limited to use in this specific lung nodule detection application and could be employed to detect other features in various types of images having predetermined curvature, size and shape characteristics.

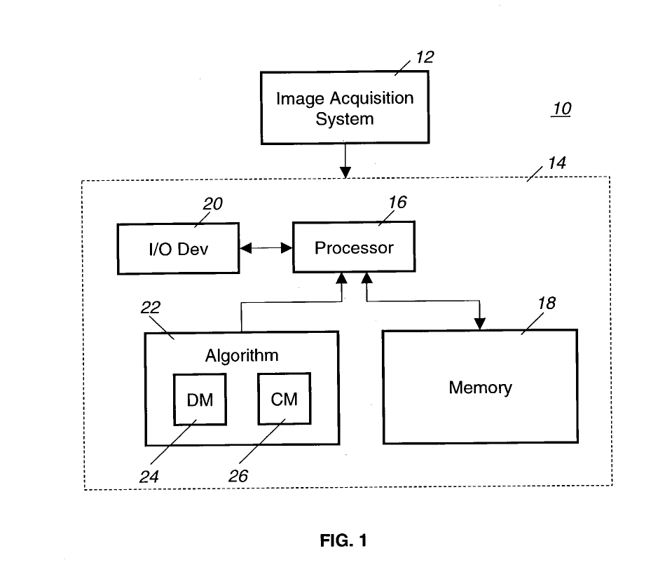

FIG. 1 illustrates a CT image acquisition and analysis system 10 for detection and classification of lung nodules in accordance with the subject algorithm. The system 10 includes a CT image acquisition system 12, which generates CT 3-dimensional volume images of a person's thorax. As is conventional, each of the 3D volume images is a digital image that is formed of an array of pixels. Each pixel is assigned a gray level value that identifies the pixel's relative brightness in a range between black and white. The 3D volume images are separated into 2-dimensional image slices and are fed into a programmable computer 14, which can be any suitable computer, such as a PC. As is conventional, the computer 14 includes a processor 16, a memory 18 and a number of conventional I/O devices 20, which can include a keyboard, a mouse, a monitor, a printer, etc. As images are generated by the image acquisition system 12, they are fed into the computer 14 and stored in the memory 18 for subsequent analysis. To carry out this analysis, the processor 16 is programmed to analyze each image slice through execution of a detection and classification algorithm 22 that includes a detection module 24 and a classification module 26.

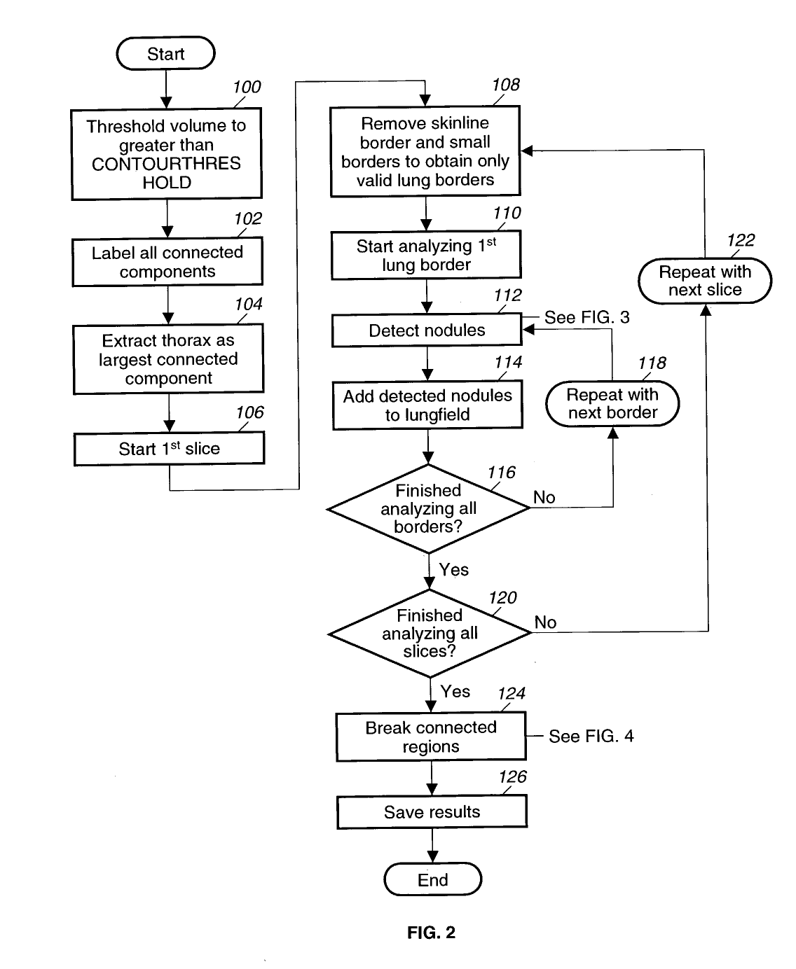

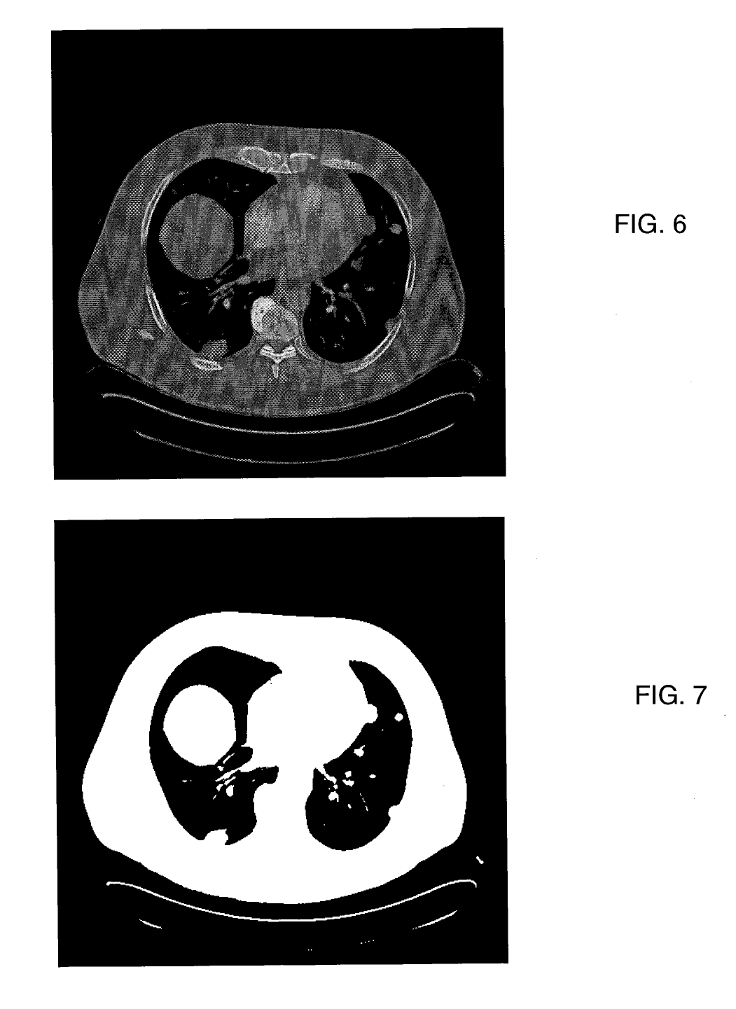

FIGS. 2-4 are flow charts that illustrate the steps carried out by the detection module 24 of the algorithm 22. This portion of the algorithm 22 consists of the following processing steps. With reference to FIG. 2, after an initialization procedure in which a 3D volume image to be analyzed is read in and various program constants are set, the algorithm starts with a thresholding step 100. During this step, the volume image is thresholded by comparing each pixel value in the image to a predetermined value, CONTOURTHRESHOLD, to obtain a binary image in which 1's are set where the pixel value is greater than this limit and 0 otherwise. The binary image will consist of several disconnected regions. FIG. 6 is a sample image slice of a 3D volume image of a person's thorax prior to the image being thresholded, while FIG. 7 is the same image slice after thresholding.

Next, all connected components in the thresholded image are identified and labeled at step 102. The largest connected component or region in the image will be the thorax, which is extracted at step 104. The next group of steps is then performed on the image one slice at a time beginning with the first slice at step 106. At step 108, the inner and outer borders of the thorax are extracted to form a border image for each slice, preferably using the known morphological dilate operator. The inner borders are the lung borders and borders of other small spurious regions. The outer border is the skinline border. During this step, large and small size thresholding is employed to remove the skinline border (larger than LARGE_REGIONS) and the small spurious borders (smaller than SMALL_REGIONS), leaving only the lung borders.

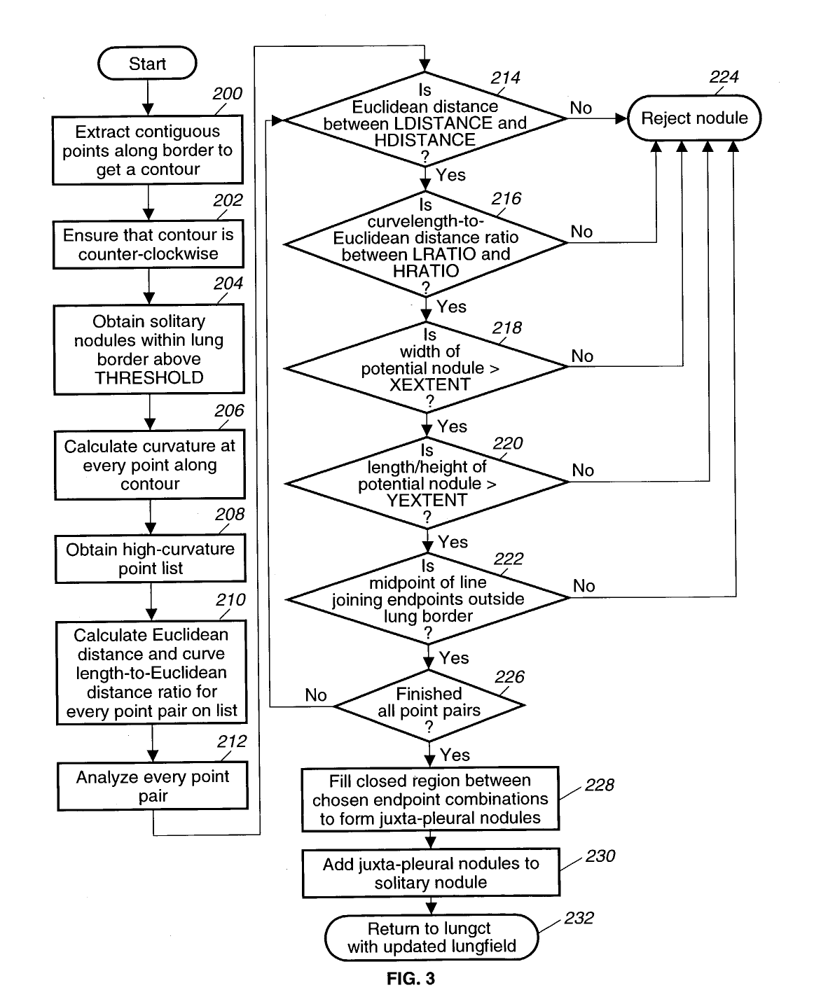

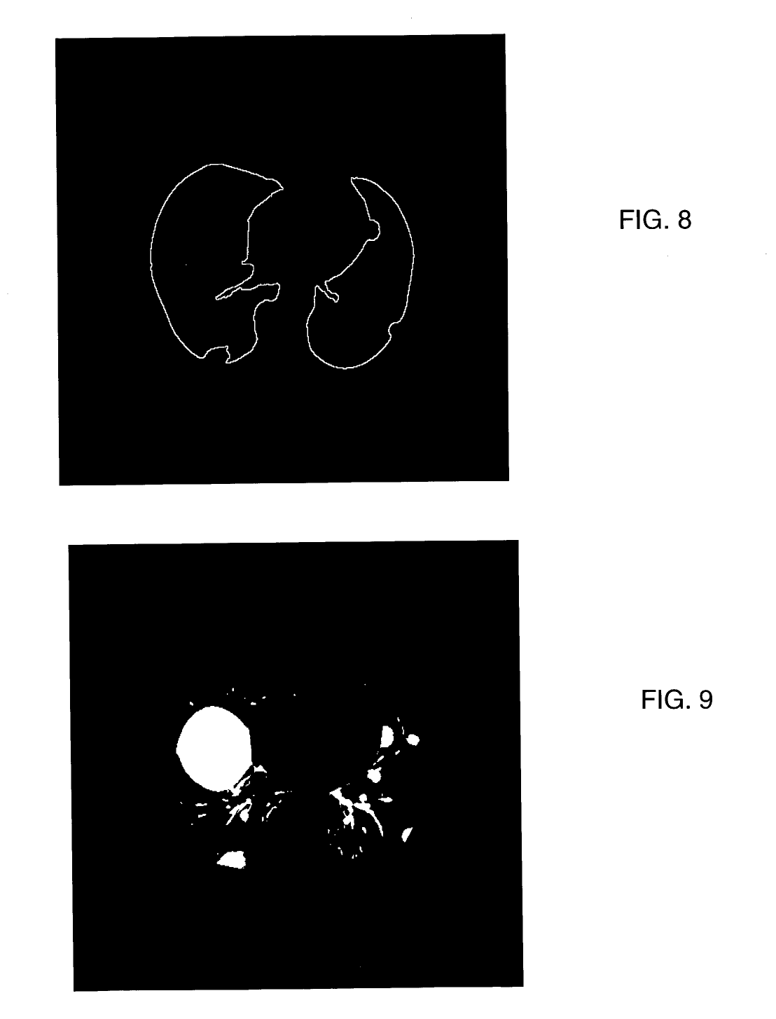

After step 108 is complete, lung borders will remain as illustrated in FIG. 8. Within each lung border, lung nodules may be present, these being of two types: juxta-pleural and solitary. Juxta-pleural nodules are those that are attached to the inner wall of the lung and can be detected through analysis of the lung border. Solitary nodules appear within the lung and can be detected through gray level analysis. At step 110, a first of the lung borders is selected for analysis. Next, at step 112, potential lung nodules are detected, with juxta-pleural nodules being detected by curvature, size and shape analysis and solitary nodules being detected as those pixels within each lung border which have gray value greater than THRESHOLD. The steps carried out during the curvature, size and shape analysis are illustrated in detail in FIG. 3 and will be discussed in conjunction therewith shortly.

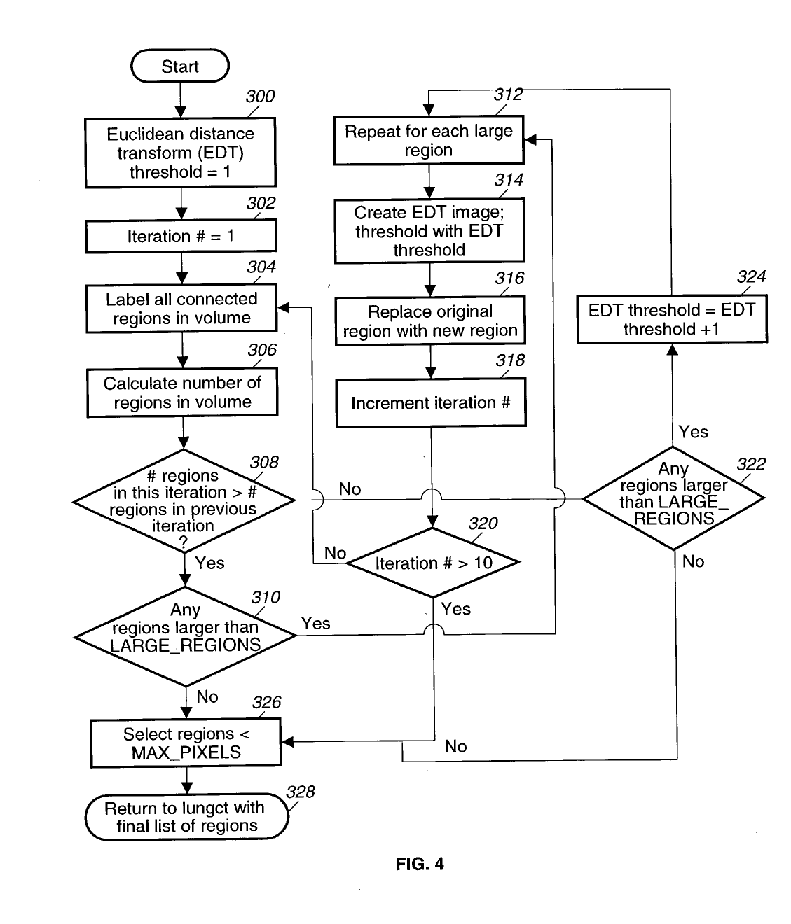

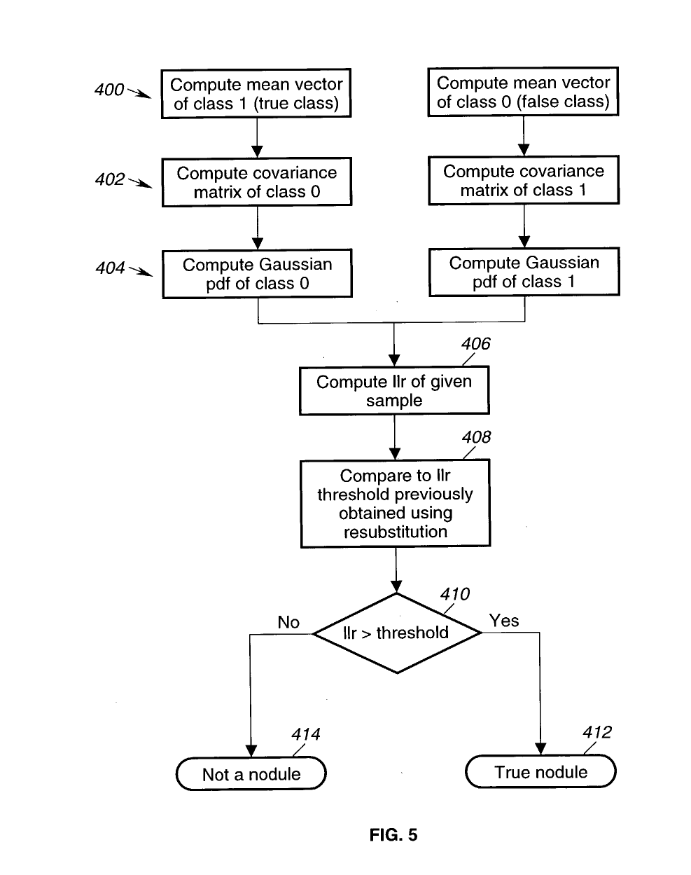

Once the lung nodule detection process is complete, all detected nodule candidates are added to a database named “lungfield” at step 114. At step 116, a query is made whether all lung borders have been analyzed. If not, the next border is selected for analysis at step 118 and the program returns to step 112. If both lung borders have been analyzed, the program goes to the next query at step 120 to determine whether all slices of the 3D volume image have been analyzed. If not, the program selects the next slice for analysis at step 122 and returns to the lung border extraction step 108. If all slices of the image have been analyzed, then the program proceeds at step 124 to an image processing routine that identifies and separates concatenated nodules that may have been identified during the previous detection steps. The image processing routine is an iterative process that is illustrated in FIG. 4 and discussed in detail in conjunction therewith below. Finally, at step 126, the results of the detection process are saved for subsequent classification by the classification module 26, which is illustrated in FIG. 5 and discussed later in conjunction therewith.

With reference to the flowchart in FIG. 3, the steps employed to detect juxta-pleural and solitary nodules are illustrated. After setting of various constants employed in this sub-module, contiguous pixels along the lung border in the image slice are extracted in step 200 using a procedure called vertices to generate a contour for curve analysis. The original contour may not have points one next to the other, so that vertices may have to be iteratively calculated using distances of increasing size to skip over to connect points to obtain the final contiguous border. This could happen because of the convoluted nature of the border as well as because of loops in the border. At step 202, the program insures that the contour proceeds in one direction, in this case, counter-clockwise, though clockwise could work as well. Before the curve analysis is performed, solitary nodules within the lung border are detected at step 204 by identifying pixels with a gray level above the predetermined value, THRESHOLD.

Next, at step 206, the curvature along every point of the contour is calculated using a polynomial function. This function calculates the curvature at every point along the border contour by fitting a 2^{nd} degree polynomial over a set of points with the current point in the center. The 1^{st} and 2^{nd} derivatives of X and Y X′, Y′, X ″ and Y″) for the resulting polynomial are calculated analytically and the curvature C at the point is given by

$$C = \frac{{X}^{′} {Y}^{″} - {Y}^{′} {X}^{″}}{{( {X}^{′ 2} + {Y}^{′ 2} )}^{1.5}} .$$

In the preferred embodiment, 10 points are employed, though other numbers of points obviously could be employed. The number of points should be sufficient, however, that when using a polynomial fit at each point, the effect due to small irregularities in the border which could get incorrectly identified as nodules is minimized. Use of the polynomial to determine curvature is advantageous for a couple reasons. By modeling the curve as a polynomial at every point, exact mathematical expressions are obtained for the first and second derivative and hence curvature, which depends on these values, can be calculated more accurately. The “ends” of the nodules are thus found much more reliably and hence accurate segmentation of the nodules is possible. It should be noted that although use of a polynomial fit works well, other types of curve-fitting procedures (e.g. spline) might work equally well or even better, though no testing on any other procedures have been performed at present.

Once all of the curvature values have been calculated, curvature values greater than a value, CTHRESHOLD, are identified in step 208 and collected in a separate list. Since the curvature is expected to peak on either side of a nodule, pairs of these high curvature points are then analyzed in the following manner to determine which can define end points of regions in the image slice that represent potential nodules. First, at step 210, the Euclidean distance between point pairs and the curve length-to-Euclidean distance ratio between point pairs are calculated. Next, every point pair is analyzed at step 212. To define a potential nodule, a point pair must satisfy each of five criteria as indicated in a number of query blocks 214, 216, 218, 220 and 222. These criteria are selected based on known size and shape characteristics of lung nodules and are: 1) the point pair must have a Euclidean distance within a certain range (LDISTANCE and HDISTANCE) (block 214); 2) the ratio between curve length and Euclidean distance must be within a certain range (LRATIO and HRATIO) (block 216); 3) the maximum width of the potential nodule must be greater than XEXTENT (block 218); 4) the maximum length/height of a potential nodule must be greater than YEXTENT (block 220); and, 5) the midpoint of the line joining the endpoints of the potential nodule must be outside the lung border (block 222), since true juxta-pleural nodules are expected to be outside the lung border. If any of the foregoing criteria is not met, the point pair is rejected at step 224 as not defining a region that represents a potential nodule.

In the preferred embodiment, the values of the various parameters are selected as follows, although these parameters could be further optimized with larger data sets:

MAX_VOLUME=(4.0/3.0)π(20.0)³ cubic mm

MAX_PIXELS=MAX_VOLUME/(xsize·ysize·zsize) pixels

SMALL_REGIONS=150 pixels

THRESHOLD=500 gray values

CONTOURTHRESHOLD=780 gray values

LARGE_REGIONS=12000 pixels

LRATIO=1.5

HRATIO=15.0

LDISTANCE=3 pixels

HDISTANCE=50 pixels

XEXTENT=50 pixels

YEXTENT=50 pixels

CTHRESHOLD=0.2 per pixel

Once each point pair in the border contour has been analyzed (query block 226), the program proceeds to step 228 and a nodule is created by filling the closed region of the lung border curve between the two endpoints. These filled nodules are added to the image containing solitary nodules at step 230 and result in an image that appears like the one in FIG. 9. The program then returns to step 114 of FIG. 2 for processing of another border or slice.

FIG. 4 illustrates the iterative process employed at step 124 of FIG. 1 to break up large connected regions that are created during the nodule detection process. After all slices have been analyzed as described above, the process of FIG. 4 is used to break up regions that exceed a selected size threshold that is likely to contain concatenated nodules. The procedure uses the Euclidean distance transform (EDT) operator in an iterative manner. Repeated application of the EDT to the 3D image volume will separate regions that exceed the size threshold into smaller regions until no such regions remain.

First, at step 300, the EDT is applied to the 3D image volume using an initial Euclidean distance threshold of 1. The number of the iteration is then initialized to 1 at step 302. At step 304, all connected regions in the image volume are labeled. Next, at step 306, the number of independent regions in the image volume is calculated and then this number is compared at step 308 to the number obtained during the previous iteration (of course this number is zero if the present iteration is the first iteration). If the answer is yes, then at step 310, the algorithm determines whether any regions larger than the threshold, LARGE_REGIONS remain. For all but the first iteration, if the number of regions has increased, this means that the last application of the EDT resulted in the separation of at least one large region. Under these circumstances, if additional regions larger than the threshold remain, then the EDT operator should be applied again at steps 312 and 314. After the EDT operator is applied, the region resulting from the EDT threshold operation at step 316 replaces the current large region. The iteration number is then increased at step 318 and if the iteration number is not greater than a pre-selected max (in this case, 10) as determined at step 320, then the algorithm returns to step 308 for the next iteration. If, at step 308, the number of regions remains the same as in the previous iteration, but at step 322, it is determined that regions larger than LARGE_REGIONS still remain, then this is an indication that the EDT operator did not separate any large regions and the EDT threshold must be increased. At step 324, the EDT threshold is thus increased by 1 and the procedure is repeated beginning at step 312. Once either the iteration count exceeds 10 at step 320 or no regions larger than LARGE_REGIONS remain at step 310, all 3D regions larger than MAX_PIXELS are excluded at step 326 and the remaining regions are selected as the potential lung nodule candidates. The algorithm then returns at step 328 to step 126 of the detection algorithm of FIG. 2 where all remaining regions, which make up the final set of lung nodule candidates, are saved for processing by the classifier module.

A flow chart for the classifier module is illustrated in FIG. 5. The classifier module uses a multi-feature Bayesian quadratic classifier based on eigenvalue and gray level analysis to remove false positive detections. In the preferred embodiment, three features are employed to minimize complexity of the analysis, although additional features could be employed if desired. The features used in the preferred embodiment are (1) the ratio of minimum and maximum eigenvalues of the co-variance matrix of the pixel coordinates making up each nodule candidate; (2) the maximum eigenvalue of the co-variance matrix; and, (3) average gray value of the pixels in the nodule candidate. The eigenvalue features are used to distinguish long thin structures (which are more indicative of bronchial false positives) from true nodules (which are more likely to be round). The average gray level feature is used to remove false positives that are either brighter or darker than typical nodules. Other features that could be employed include variance of the gray level within a detection, as well as roughness (circularity, sphericity, compactness, etc.) measures. However, in order to ensure generalizability to an unknown dataset, a much larger dataset would have to be employed if these features were added.

Since truth is available for the dataset, the entire set of nodule candidates emerging from the detection module can be divided into true and false classes (classes 1 and 0, respectively). The following steps are applied to each class. At step 400, the mean vectors m₀ and m₁ are computed, one for each class. The mean vector m₁ consists of 3 numbers (the mean value of the 3 features for class 0), as does the mean vector m₁ (the mean value of the 3 features for class 1). Next, at step 402, the covariance matrix for each class is calculated. Cᵢ is the co-variance matrix for class i, where each element cᵢⱼ in the covariance matrix is given by

cᵢⱼ₌E{(xᵢ₋mᵢ)(xⱼ₋mⱼ)}

where xᵢ are the values of a particular one of the three features, and xⱼ are the values of a different one of the features, with the m's being their means. E refers to the expected value or the mean of the quantity within brackets. C₀ is the co-variance matrix obtained using feature values for the 3 features for class 0, and similarly C₁ is the covariance matrix obtained using feature values for the 3 features for class 1.

In step 404, each class is modeled as a multivariate Gaussian distribution with a probability density function, pdf, given by

$${pdf}_{i} ( \vec{x} ) = \frac{1}{{( 2 π )}^{\frac{n}{2}} \sqrt{\vert {C}_{i} \vert}} {ⅇ}^{- \frac{1}{2} {( \vec{x} - {\vec{m}}_{i} )}^{T} {C}_{i}^{- 1} ( \vec{x} - {\vec{m}}_{i} )}$$

Thus, using the values of the 3 features in the 2 classes, one can calculate the pdfs of the 2 classes. The pdfs are functions of \vec{x} where \vec{x} is a 3-tuple vector (for the 3 features).

Once the pdfs are calculated, the algorithm proceeds to step 406 and the log likelihood ratio (llr) value for each detection is found using the equation:

llr(\vec{x})=1n(pdf₁(\vec{x}))−1n(pdf₀(\vec{x}))

Next, at step 408, the llr value is compared to a predetermined threshold value. If greater than the threshold, the nodule is classified as a true nodule at step 412. Using Bayes' Decision Rule, if the llr value is not greater than the threshold, the nodule in question is classified as a false positive at step 414.

The classifier can be developed and tested using different samples or nodule candidates either using the same data that was used for building the classifier (resubstitution) or using unknown new data (holdout). As discussed previously, each sample is a 3-tuple vector consisting of the two eigenvalue features and the gray level feature. When different samples are passed through the llr equation, different llr values are obtained. The llr value actually gives the likelihood of belonging to either of the classes and is a monotonic function. Thus, one can classify unknown samples by setting a threshold on the llr values. The threshold value can be modified as more information is obtained. More particularly, the classifier is first constructed with known cases, and the resubstitution method is employed to obtain a good llr threshold that separates true and false nodules. Then, the same classifier with the same llr threshold can be used to classify unknown cases using the holdout method.

It should be noted that the resubstitution method suffers from bias, in that the decision process is tested using the same samples from which the distributions are estimated. However, resubstitution provides a theoretical upper bound on discrimination performance. A more unbiased estimate of performance can be obtained with either the holdout method or a leave-one-out method (also called a Jackknife method). The leave-one-out method can be interpreted as an unbiased estimate of true performance. With this method, each sample is evaluated in a round-robin fashion, using class distributions derived from all samples except the sample being tested. If there are a large number of samples, then this procedure will be computationally expensive and may yield results very similar to the resubstitution procedure. The holdout procedure used in the preferred embodiment is more practical because it provides some insight into how the algorithm will perform on unknown cases.

Using a Bayesian classifier is far superior to using rule-based schemes, neural networks or linear discriminant analysis. If designed and trained appropriately, a Bayesian classifier will provide optimum performance in terms of minimum classification error. The current implementation is a quadratic classifier, which is one that uses multivariate Gaussian distributions for the underlying probability density functions of the nodule class and non-nodule class, and is a special case of a general Bayesian classifier. If more data were available, one could provide better estimates of the probability density function for the 2 classes and still use Bayes' Decision Rule. However, in the absence of sufficient data and when the exact form of the probability density functions is not known, reasonable performance can still be achieved by using Gaussian distributions. In contrast with neural networks, a Bayesian classifier provides a more statistically understandable parameterization of the problem and provides improved ability to assess classification uncertainty.

Testing of the subject lung nodule detection and classification algorithm confirm that the results obtained therewith are superior to the literature for comparable data (above 3 mm slice resolution). The algorithm also has several other advantages in addition to those already noted over those presented in the literature. The unique curvature analysis employed in the detection module has the added advantage that it does not need separation of the two lungs to perform proper segmentation of juxta pleural nodules. In addition, the curvature analysis is not limited like other known techniques, which only detect nodules that are circular or semi-circular in shape. The algorithm uses only 2 thresholds (one for lung contour identification and one for solitary pulmonary nodule identification), while other known techniques must rely on the use of multiple thresholds. A very simple size threshold is also employed to remove unwanted image portions, such as the diaphragm, thorax, main bronchi, etc., thus avoiding the need for complicated discrimination algorithms.

Although the invention has been disclosed in terms of a preferred embodiment and variations thereon, it will be understood that numerous additional variations and modifications could be made thereto without departing from the scope of the invention as set forth in the attached claims. For example, in the present implementation of the detection module, a rule-based approach using empirically determined thresholds is used to pair contour points appropriately so that juxta-pleural nodules are identified correctly. A classifier approach similar to that employed in the classifier module could also be used to achieve the same result. The values used in the rules could be used as features in the classifier. The classifier could then be used to automatically determine which of these rules are important by performing a feature selection. This procedure could be expected to be more robust and capable of being generalized to an unknown dataset.

Presently, the actual analysis for juxta-pleural nodules is done slice-by-slice. A 3D approach could also be used to detect juxta-pleural nodules. However, this would involve a 3D curvature implementation that could be computationally expensive. The current implementation of the algorithm also does not use information from adjacent slices to reduce false-positives and for improved detection of nodules. Some studies in the literature have reported that the extension of large organs in a particular slice to adjacent slices could mimic small nodules due to partial volume effect and these could be eliminated by checking for the presence of large regions in the neighborhood of detections. This could easily be included in the algorithm to improve its specificity. False positives due to the incursion of the heart and other organ borders into the lung could also be addressed by using a priori information about the location and shape of the heart.

1. A method for detecting features of predetermined size and shape in an image comprising the steps of:
identifying at least a first border of an object in said image, said border being defined by a plurality of points defined by a plurality of pixels in said image;
calculating a curvature value for said border at each of said points;
identifying a set of high curvature points selected from said plurality of points where said border has a curvature value greater than a threshold value; and
generating a set of regions in said image, each of which represents a potential feature of said predetermined size and shape, by analyzing pairs of said high curvature points to determine whether the points in each pair potentially define a region representing one of said features.

2. The method of claim 1, wherein said pairs of said high curvature points are analyzed by:
calculating the Euclidean distance between each pair of high curvature points;
calculating the curve-length-to-Euclidean-distance ratio between each pair of high curvature points; and
determining that a pair of said high curvature points potentially defines a region representing a feature of said predetermined size and shape if the Euclidean distance is within a first specified range and the ratio between curve length and Euclidean distance is within a second specified range.

3. The method of claim 2, wherein said object is a lung, said features to be detected comprise lung nodules and wherein each pair of high curvature points is further analyzed by:
calculating a maximum length and a maximum width of a region defined by said pair of high curvature points;
determining whether a midpoint of a line joining said pair of high curvature points is inside the lung border; and
determining that said pair of points defines a region representing a juxta-pleural lung nodule along said border of said lung unless said maximum length exceeds a first threshold, said maximum width exceeds a second threshold, or said midpoint of said line is inside said lung border.

4. The method of claim 1, wherein said object is a lung and said features to be detected comprise lung nodules.

5. The method of claim 4, further comprising the steps of:
identifying pixels in said image that are within said lung border and have a gray level value above a threshold; and
determining that any such pixels define solitary nodules with said lung.

6. The method of claim 4, wherein said step of identifying at least a first border of a lung in said image comprises:
thresholding said image to assign binary values to each pixel in said image;
identifying inner and outer borders of a person's thorax in said thresholded image; and
applying a large and a small size threshold to said inner and outer borders to identify said at least one lung borders.

7. The method of claim 1, further comprising the steps of:
determining whether any of said regions in said set are likely to be concatenated with one another and if so;
repeatedly applying a Euclidian distance transform operator to said set of regions to separate any concatenated regions therein.

8. The method of claim 1, wherein said step calculating a curvature value for every point along said border comprises:
generating a contour of image pixels along said border; and
calculating the curvature at every pixel along said contour using a polynomial equation that is fit over a set of multiple pixels with the pixel, whose curvature is to be determined, in the center of said set of multiple pixels.

9. The method of claim 8, wherein said polynomial is a 2^{nd} degree polynomial.

10. The method of claim 1, further comprising the step of classifying each region is said set of regions as being either true or false, where true defines a first subset of said regions that actually represent features of said predetermined size and shape, and false defines a second subset of said regions that do not represent features of said predetermined size and shape.

11. The method of claim 10, wherein said step of classifying further comprises:
employing a plurality of characteristic features that are known to distinguish true regions from false regions in a Bayesian classifier that generates a probability density function for each of said classes;
employing said probability density functions to calculate a log likelihood ratio for each region; and
classifying regions that have a log likelihood ratio exceeding a predetermined value as true, and classifying all other regions as false.

12. The method of claim 11, wherein said Bayesian classifier is a multivariate Gaussian distribution.

13. The method of claim 11, wherein said predetermined value is initially determined based on analysis of known regions.

14. The method of claim 11, wherein said characteristic features include eigenvalues and gray levels of pixels in said image that make up each of said regions that represent potential features of said predetermined size and shape.

15. A method for detecting features of predetermined size and shape along a border of an object in an image comprising the steps of:
generating a set of regions in said image corresponding to potential features of said predetermined size and shape; and
classifying each region is said set of regions as being either true or false, where true defines a first subset of said regions that actually represent features of said predetermined size and shape, and false defines a second subset of said regions that do not represent features of said predetermined size and shape.

16. The method of claim 15, wherein said step of classifying further comprises:
employing a plurality of characteristic features that are known to distinguish true regions from false regions in a Bayesian classifier that generates a probability density function for each of said classes;
employing said probability density functions to calculate a log likelihood ratio for each region; and
classifying regions that have a log likelihood ratio exceeding a predetermined value as true, and classifying all other regions as false.

17. The method of claim 16, wherein said Bayesian classifier is a multivariate Gaussian distribution.

18. The method of claim 16, wherein said predetermined value is initially determined based on analysis of known regions.

19. The method of claim 16, wherein said characteristic features include eigenvalues and gray levels of pixels in said image that make up each of said regions that represent potential features of said predetermined size and shape.

20. The method of claim 16, wherein said object is a lung and said features to be detected comprise lung nodules.

21. A system for detecting features of predetermined size and shape in an image comprising:
an image acquisition system for generating one or more images; and
a computer including a memory for storing said images received from said image acquisition system and a processor for analyzing said images that is programmed with an algorithm that carries out the steps of:
identifying at least a first border of an object in each of said images, said border being defined by a plurality of points defined by a plurality of pixels in said image;
calculating a curvature value for said border at each of said points;
identifying a set of high curvature points selected from said plurality of points where said border has a curvature value greater than a threshold value; and
generating a set of regions in each said image, each of which represents a potential feature of said predetermined size and shape, by analyzing pairs of said high curvature points to determine whether the points in each pair potentially define a region representing one of said features.

22. The system method of claim 21, wherein said pairs of said high curvature points are analyzed by:
calculating the Euclidean distance between each pair of high curvature points;
calculating the curve-length-to-Euclidean-distance ratio between each pair of high curvature points; and
determining that a pair of said high curvature points potentially defines a region representing a feature of said predetermined size and shape if the Euclidean distance is within a first specified range and the ratio between curve length and Euclidean distance is within a second specified range.

23. The system of claim 22, wherein said images are CT images of a person's thorax, said object in said images is a lung, said features to be detected comprise lung nodules and wherein said algorithm further analyzes each pair of high curvature points by:
calculating a maximum length and a maximum width of a region defined by said pair of high curvature points;
determining whether a midpoint of a line joining said pair of high curvature points is inside the lung border; and
determining that said pair of points defines a region representing a juxta-pleural lung nodule along said border of said lung unless said maximum length exceeds a first threshold, said maximum width exceeds a second threshold, or said midpoint of said line is inside said lung border.

24. The system of claim 21, wherein said object is a lung and said features to be detected comprise lung nodules.

25. The system of claim 24, wherein said algorithm further carries out the steps of:
identifying pixels in each said image that are within said lung border and have a gray level value above a threshold; and
determining that any such pixels define solitary nodules with said lung.

26. The system of claim 24, wherein said step of identifying at least a first border of a lung in said image comprises:
thresholding each said image to assign binary values to each pixel in said image;
identifying inner and outer borders of a person's thorax in said thresholded image; and
applying a large and a small size threshold to said inner and outer borders to identify said at least one lung borders.

27. The system of claim 21, wherein said algorithm further carries out the steps of:
determining whether any of said regions in said set are likely to be concatenated with one another and if so;
repeatedly applying a Euclidian distance transform operator to said set of regions to separate any concatenated regions therein.

28. The system of claim 21, wherein said step calculating a curvature value for every point along said border comprises:
generating a contour of image pixels along said border; and
calculating the curvature at every pixel along said contour using a polynomial equation that is fit over a set of multiple pixels with the pixel, whose curvature is to be determined, in the center of said set of multiple pixels.

29. The system of claim 28, wherein said polynomial is a 2^{nd} degree polynomial.

30. The system of claim 21, wherein said algorithm further carries out the step of classifying each region is said set of regions as being either true or false, where true defines a first subset of said regions that actually represent features of said predetermined size and shape, and false defines a second subset of said regions that do not represent features of said predetermined size and shape.

31. The system of claim 30, wherein said step of classifying further comprises:
employing a plurality of characteristic features that are known to distinguish true regions from false regions in a Bayesian classifier that generates a probability density function for each of said classes;
employing said probability density functions to calculate a log likelihood ratio for each region; and
classifying regions that have a log likelihood ratio exceeding a predetermined value as true, and classifying all other regions as false.

32. The system of claim 31, wherein said Bayesian classifier is a multivariate Gaussian distribution.

33. The system of claim 31, wherein said predetermined value is initially determined based on analysis of known regions.

34. The system of claim 31, wherein said characteristic features include eigenvalues and gray levels of pixels in said image that make up each of said regions that represent potential features of said predetermined size and shape.

35. A system for detecting features of predetermined size and shape along a border of an object in an image comprising:
an image acquisition system for generating one or more images; and
a computer including a memory for storing said images received from said image acquisition system and a processor for analyzing said images that is programmed with an algorithm that carries out the steps of:
generating a set of regions in each said image corresponding to potential features of said predetermined size and shape; and
classifying each region is said set of regions as being either true or false, where true defines a first subset of said regions that actually represent features of said predetermined size and shape, and false defines a second subset of said regions that do not represent features of said predetermined size and shape.

36. The system of claim 35, wherein said step of classifying further comprises:
employing a plurality of characteristic features that are known to distinguish true regions from false regions in a Bayesian classifier that generates a probability density function for each of said classes;
employing said probability density functions to calculate a log likelihood ratio for each region; and
classifying regions that have a log likelihood ratio exceeding a predetermined value as true, and classifying all other regions as false.

37. The system of claim 36, wherein said Bayesian classifier is a multivariate Gaussian distribution.

38. The system of claim 36, wherein said predetermined value is initially determined based on analysis of known regions.

39. The system of claim 36, wherein said characteristic features include eigenvalues and gray levels of pixels in said image that make up each of said regions that represent potential features of said predetermined size and shape.

40. The system of claim 36, wherein said object is a lung and said features to be detected comprise lung nodules.
